(19) United States
(12) Patent Application Publication
(10) Pub. No.: US 2011/0072128 A1
(43) Pub. Date: Mar. 24, 2011

(54) AUTOMATED PRESENCE RANKING FOR COMMUNICATIONS NETWORKS

(75) Inventors: Derek W. Carr, Apex, NC (US); Michael D. Facemire, Pittsboro, NC (US); Stephan J. Roorda, Fuquay Varina, NC (US); Michael C. Wanderski, Durham, NC (US)

(73) Assignee: INTERNATIONAL BUSINESS MACHINES CORPORATION, Armonk, NY (US)

(21) Appl. No.: 12/563,135

(22) Filed: Sep. 20, 2009

(51) Int. Cl. G06F 15/173; G06F 15/16

(52) U.S. Cl. 709/224; 709/223; 709/206

(57) ABSTRACT

Messaging interactions among a set of network user access accounts is monitored at a presence server. The messaging interactions between the set of network user access accounts are ranked based upon a characteristic of the messaging interactions. A presence filtering profile is automatically configured that defines distribution controls for presence information for the set of network user access accounts based upon the determined ranking. Distribution of the presence information for the set of network user access accounts is controlled based upon the configured presence filtering profile.

### BACKGROUND

The present invention relates to regulation of distribution of presence information in communications networks. More particularly, the present invention relates to automated presence ranking for communications networks.

When a communications device enters or becomes active within communications networks, the communications device may provide presence information that documents that entry or transition to active status within the network. The presence information may be collected via a presence server or other device. Users of other communications devices may access the presence information to determine whether the communications device is active within the network and to determine a status of activity associated with the communications device.

### BRIEF SUMMARY

A method includes monitoring, at a presence server, messaging interactions among a plurality of network user access accounts; ranking the messaging interactions between the plurality of network user access accounts based upon a characteristic of the messaging interactions; automatically configuring a presence filtering profile that defines distribution controls for presence information for the plurality of network user access accounts based upon the determined ranking; and controlling distribution of the presence information for the plurality of network user access accounts based upon the configured presence filtering profile.

A system includes a memory; and a processor programmed to: monitor, at a presence server, messaging interactions among a plurality of network user access accounts; rank the messaging interactions between the plurality of network user access accounts based upon a characteristic of the messaging interactions; automatically configure a presence filtering profile that defines distribution controls for presence information for the plurality of network user access accounts based upon the determined ranking; store the automatically configured presence filtering profile within the memory; and control distribution of the presence information for the plurality of network user access accounts based upon the configured presence filtering profile.

A computer program product includes: a computer readable storage medium having computer readable program code embodied therewith, the computer readable program code including: computer readable program code configured to monitor, at a presence server, messaging interactions among a plurality of network user access accounts; computer readable program code configured to rank the messaging interactions between the plurality of network user access accounts based upon a characteristic of the messaging interactions; computer readable program code configured to automatically configure a presence filtering profile that defines distribution controls for presence information for the plurality of network user access accounts based upon the determined ranking; and computer readable program code configured to control distribution of the presence information for the plurality of network user access accounts based upon the configured presence filtering profile.

### BRIEF DESCRIPTION OF THE SEVERAL VIEWS OF THE DRAWINGS

FIG. 1 is a block diagram of an example of an implementation of a system for automated presence ranking for communications networks according to an embodiment of the present subject matter;

FIG. 2 is a block diagram of an example of an implementation of a presence server that is capable of performing automated presence ranking within communication networks according to an embodiment of the present subject matter;

FIG. 3 is a flow chart of an example of an implementation of a process for automated presence ranking for communications networks according to an embodiment of the present subject matter; and

FIG. 4 is a flow chart of an example of an implementation of a process for automated presence ranking for communications networks that automatically modifies presence filtering in response to detection of user requests to modify presence filtering according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides automated presence ranking for communications networks. Messaging interactions among a group of network user access accounts are monitored by a presence server. The messaging interactions between the group of network user access accounts are ranked based upon a characteristic of the messaging interactions, such as a number of messaging interactions. A presence filtering profile is automatically configured that defines distribution controls for presence information for the group of network user access accounts based upon the determined ranking. Distribution of the presence information for the group of network user access accounts is controlled based upon the configured presence filtering profile.

By automatically ranking presence information, network user access accounts (“user account(s)” hereinafter) that are determined to interact with one another at higher levels of messaging volume are initially provided a higher ranking and distribution of presence information among these user accounts is made available to the other user accounts within the group. As such, an example characteristic by which messaging interactions between user accounts may be ranked is a number of messaging interactions between the accounts. Other examples of characteristics by which messaging interactions between user accounts may be ranked are a topic associated with the messaging interactions, a quality of the messaging interactions (e.g., as expressed by a user of a given user account regarding a messaging interaction), and workgroup-related or task-related characteristics (e.g., again, as expressed by a user of a given user account). Many other possibilities exist for characteristics by which messaging interactions may be ranked and all are considered within the scope of the present subject matter.

In combination with ranking messaging interactions, an association may defined between subsets of user accounts based upon the ranking characteristic (in this example, of a number of interactions between the respective user accounts). Other user accounts may be blocked from receiving presence information associated with the subset of user accounts and presence information may not be distributed to the other user accounts that are not associated with the subset of user accounts. In this way, presence information may be ranked and distribution of the presence information for the associated user accounts may be controlled based upon an automatically configured presence filtering profile based upon the ranking.

A user of a first user account may generate ratings associated with messaging interactions with other user accounts. The generated rating may include, for example, a quality rating, a topic rating, or other generated rating associated with the messaging interactions between the user accounts. The automatically configured presence filtering profile may be modified to further control distribution of presence information based upon the generated ratings.

The user of the first user account may configure a quality rating and a topic rating for distribution of presence information associated with the first user account. Distribution of presence information may then be blocked from being distributed to the other user accounts when the quality rating or topic rating assigned to the other user accounts is not associated the configured quality rating or topic rating for the distribution of presence information. In this manner, users may configure distribution controls for presence information that work in conjunction with the automated presence ranking for communications networks.

Subsequently, when the first user account enters the communications network, a topic rating status and a quality rating status for the pending messaging session may be entered by the user of the user account. Distribution of presence information associated with the first user account may be blocked from being distributed to other user accounts having a topic rating status and a quality rating status different from the topic rating status and the quality rating status for the messaging session. As such, users may enter the communications network with a configured purpose for the messaging session and may block access to their presence information for other user accounts that are not associated with the configured purpose of the messaging session.

As users progress through their activities associated with the purpose for which they accessed the communications network, their purpose may change. As such, a user may generate a request to change the rating status (e.g., the topic rating status or the quality rating status) associated with the messaging session. In response, the automatically configured presence filtering profile may be modified to change the rating status associated with the messaging session. Distribution of presence information associated with the user account may then be controlled based upon the changed rating status.

Many other possibilities exist for automated presence ranking for communications networks and for modification of automatically configured presence filtering profiles. Accordingly, any such possibility is considered within the scope of the present subject matter.

The automated presence ranking for communications networks described herein may be performed in real time to allow prompt distribution controls for user accounts during messaging sessions. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

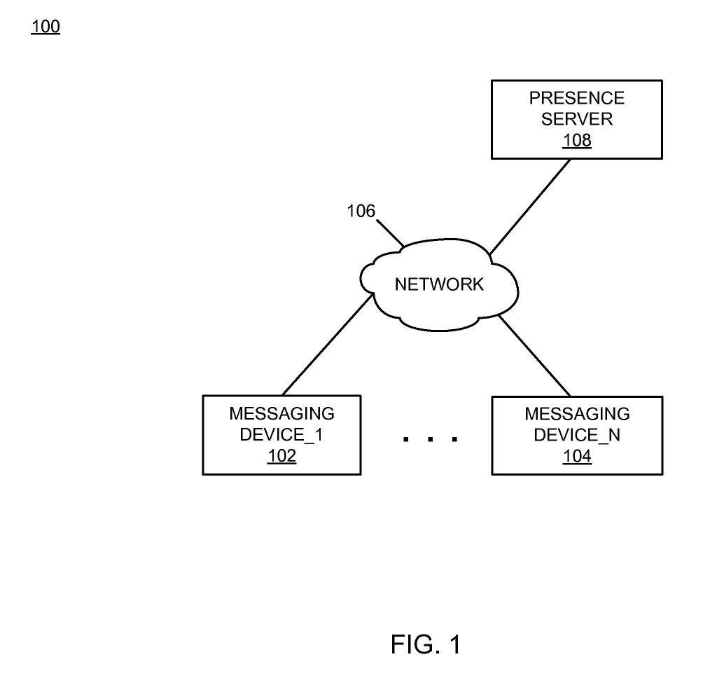

FIG. 1 is a block diagram of an example of an implementation of a system 100 for automated presence ranking for communications networks. Within the system 100, a messaging device_1 102 through a messaging device_N 104 communicate via a network 106. A presence server 108 controls distribution of presence information for user accounts associated with the messaging device_1 102 through the messaging device_N 104.

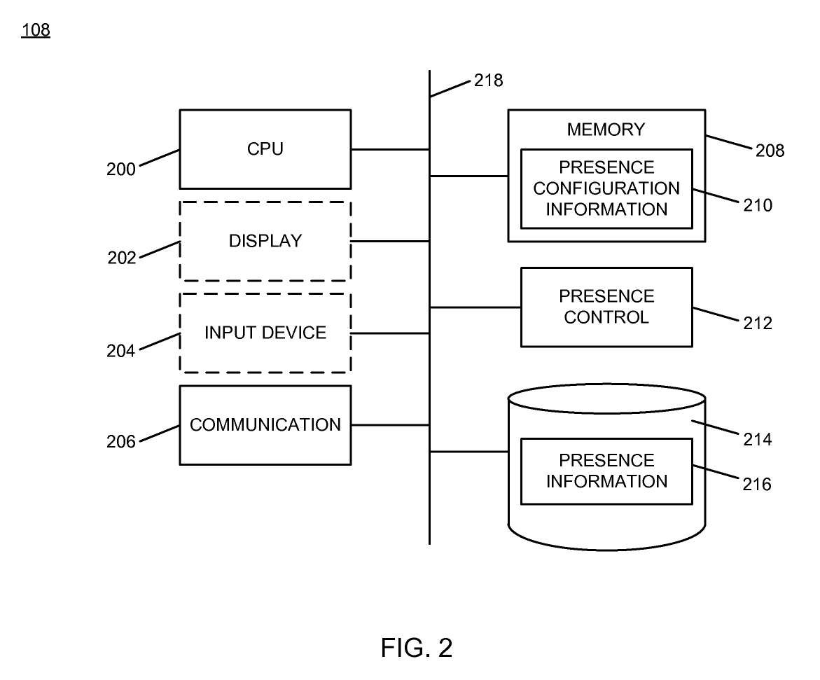

As will be described in more detail below in association with FIGS. 2 through 4, the presence server 108 provides automated presence ranking within the network 106. The presence server 108 monitors network access by user accounts associated with the messaging device_1 102 through the messaging device_N 104 and ranks messaging interactions between the respective user accounts. In addition, as described above and in more detail below, the presence server 108 automatically configures a presence filtering profile that defines distribution controls for presence information for the user accounts based upon the determined ranking. Distribution of the presence information for the plurality of user accounts is controlled based upon the configured presence filtering profile

It should be noted that the presence server 108 may be a portable computing device, either by a user's ability to move the presence server 108 to different locations, or by the presence server 108's association with a portable platform, such as a plane, train, automobile, or other moving vehicle. It should also be noted that the presence server 108 may be any computing device capable of processing information as described above and in more detail below. For example, the presence server 108 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below. The messaging device_1 102 through the messaging device_N 104 may also include any such devices.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

FIG. 2 is a block diagram of an example of an implementation of the presence server 108 that is capable of performing automated presence ranking within communication networks. A central processing unit (CPU) 200 provides computer instruction execution, computation, and other capabilities within the presence server 108. A display 202 provides visual information to a user of the presence server 108 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

It should be noted that the display 202 and the input device 204 are illustrated with a dashed-line representation within FIG. 2 to indicate that they may be optional components for the presence server 108 for certain implementations. Accordingly, the presence server 108 may operate as a completely automated embedded device without user configurability or feedback. However, the presence server 108 may also provide user feedback and configurability via the display 202 and the input device 204, respectively.

A communication module 206 provides interconnection capabilities that allow the presence server 108 to communicate with other modules within the system 100, such as the messaging device_1 102 through the messaging device_N 104, to perform the automated presence ranking within communication networks described herein. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes a presence configuration information storage area 210 that stores ranking and configuration information for distribution of presence information for the messaging device_1 102 through the messaging device_N 104 at the presence server 108. The ranking and configuration information may include an automatically configured presence filtering profile based upon determined ranking information associated with messaging interactions among the user accounts associated with the messaging device_1 102 through the messaging device_N 104. As will be described in more detail below, the ranking and configuration information stored within the presence configuration information storage area 210 is used to control distribution of presence information for user accounts associated with the messaging device_1 102 through the messaging device_N 104 based upon a configured presence filtering profile.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, a code execution area, and a data area without departure from the scope of the present subject matter.

A presence control module 212 is also illustrated. The presence control module 212 provides presence distribution controls for the presence server 108, as described above and in more detail below, based upon rankings determined from messaging interactions among user accounts and input requests received via the messaging device_1 102 through the messaging device_N 104 regarding distribution of presence information associated with the respective device(s). The presence control module 212 implements the automated presence ranking within communication networks of the presence server 108.

Though the presence control module 212 is illustrated as a component-level module for ease of illustration and description purposes, it should be noted that the presence control module 212 may include any hardware, programmed processor(s), and memory used to carry out the functions of this module as described above and in more detail below. For example, the presence control module 212 may include additional controller circuitry in the form of application specific integrated circuits (ASICs), processors, and/or discrete integrated circuits and components for performing communication and electrical control activities associated with the respective devices. Additionally, the presence control module 212 may also include interrupt-level, stack-level, and application-level modules as appropriate. Furthermore, the presence control module 212 may include any memory components used for storage, execution, and data processing for performing processing activities associated with the module.

It should also be noted that the presence control module 212 may form a portion of other circuitry described without departure from the scope of the present subject matter. Further, the presence control module 212 may alternatively be implemented as an application stored within the memory 208. In such an implementation, the presence control module 212 may include instructions executed by the CPU 200 for performing the functionality described herein. The CPU 200 may execute these instructions to provide the processing capabilities described above and in more detail below for the presence server 108. The presence control module 212 may form a portion of an interrupt service routine (ISR), a portion of an operating system, a portion of a browser application, or a portion of a separate application without departure from the scope of the present subject matter.

A database 214 is associated with the presence server 108 and provides storage capabilities for information associated with the automated presence ranking within communication networks of the presence server 108. The database 214 includes a presence information storage area 216 that may be stored in the form of tables or other arrangements accessible by the presence server 108. The presence information storage area 216 includes presence information for user accounts associated with the messaging device_1 102 through the messaging device_N 104 that are active within the network 106 at any given time. Distribution of the presence information stored within the presence information storage area 216 may be controlled based upon configured presence filtering profiles, as described herein.

The CPU 200, the display 202, the input device 204, the communication module 206, the memory 208, the presence control module 212, and the database 214 are interconnected via an interconnection 218. The interconnection 218 may include a system bus, a network, or any other interconnection capable of providing the respective components with suitable interconnection for the respective purpose.

While the presence server 108 is illustrated with and has certain components described, other modules and components may be associated with the presence server 108 without departure from the scope of the present subject matter. Additionally, it should be noted that, while the presence server 108 is described as a single device for ease of illustration purposes, the components within the presence server 108 may be co-located or distributed and interconnected via a network without departure from the scope of the present subject matter. For a distributed arrangement, the display 202 and the input device 204 may be located at a kiosk or other location, while the CPU 200 and memory 208 may be located at a local or remote server. Many other possible arrangements for components of the presence server 108 are possible and all are considered within the scope of the present subject matter. It should also be understood that, though the presence information storage area 216 is shown within the database 214, it may also be stored within the memory 208 without departure from the scope of the present subject matter. Accordingly, the presence server 108 may take many forms and may be associated with many platforms.

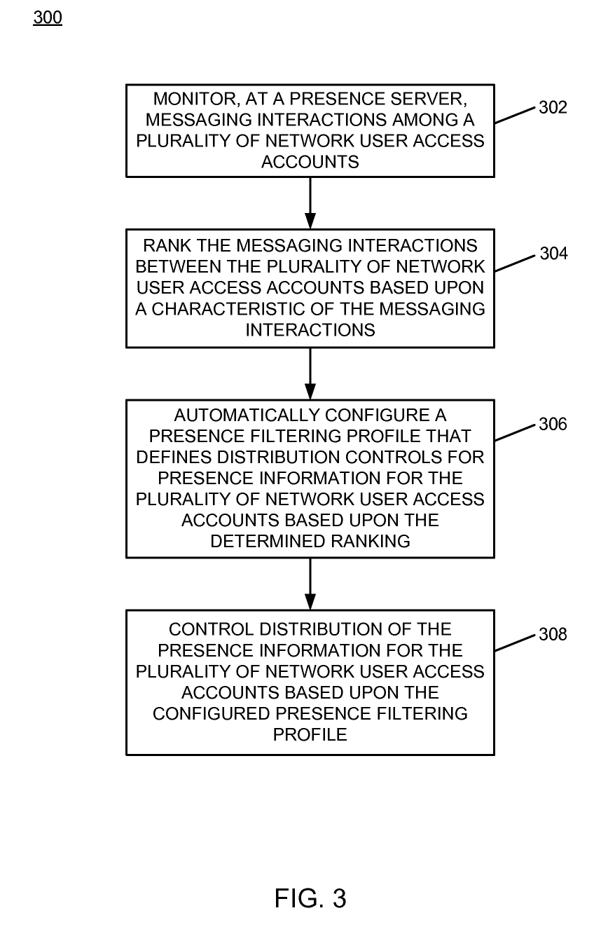

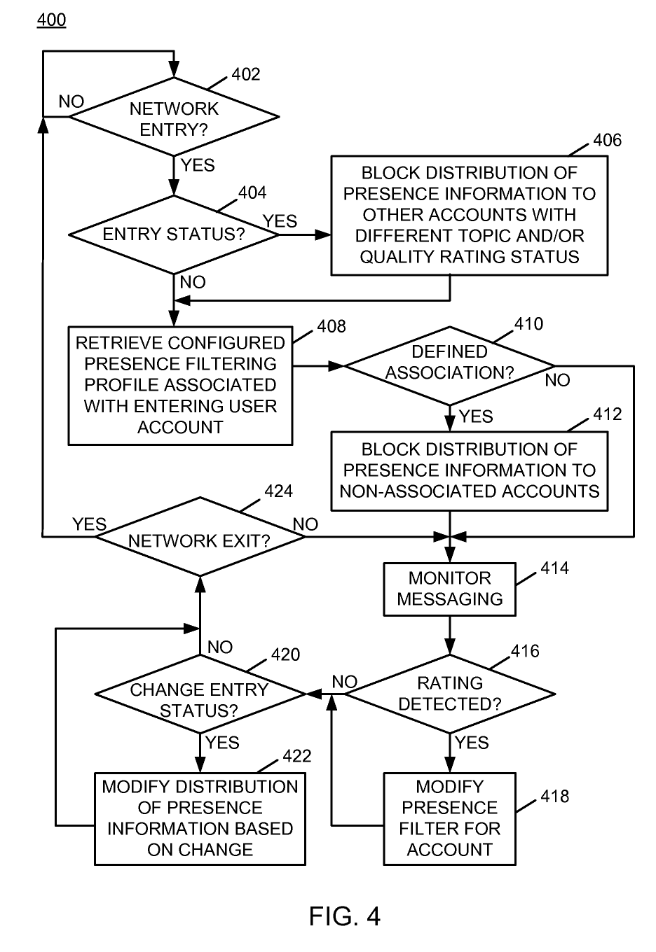

FIG. 3 through FIG. 4 below describe example processes that may be executed by devices, such as the presence server 108, to perform the automated presence ranking within communication networks associated with the present subject matter. Many other variations on the example processes are possible and all are considered within the scope of the present subject matter. The example processes may be performed by modules, such as the presence control module 212 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for automated presence ranking for communications networks. At block 302, the process 300 monitors, at a presence server, messaging interactions among a plurality of network user access accounts. At block 304, the process 300 ranks the messaging interactions between the plurality of network user access accounts based upon a characteristic of the messaging interactions. At block 306, the process 300 automatically configures a presence filtering profile that defines distribution controls for presence information for the plurality of network user access accounts based upon the determined ranking. At block 308, the process 300 controls distribution of the presence information for the plurality of network user access accounts based upon the configured presence filtering profile.

FIG. 4 is a flow chart of an example of an implementation of a process 400 for automated presence ranking for communications networks that automatically modifies presence filtering in response to detection of user requests to modify presence filtering. At decision point 402, the process 400 makes a determination as to whether a network entry event has been detected in association with a user account. A network entry may be detected by massaging associated with a device, such as one of the messaging device_1 102 through the messaging device_N 104, registering for access to a network, such as the network 106.

At decision point 404, the process 400 makes a determination as to whether a network entry status, such as a topic rating status and a quality rating status, has been received in association with the network entry event for the user account. A selection of an entry status may be detected, such as within a graphical user interface (GUI) associated with the respective messaging device that is entering the network 106. For example, a GUI for such a messaging device may include selection options, such as via a drop down list, for configured entry status options. For purposes of the present example, a topic rating status may include “work on project alpha” and a quality rating status may include “three rated or higher” for communications. Many other possibilities exist for rating status options and all are considered within the scope of the present subject matter. Accordingly, a topic rating status and/or a quality rating status may be received by the process 400 at decision point 404.

When a determination is made that a network entry status has been received at decision point 404, the process 400 blocks distribution of presence information associated with the user account from being distributed to other user accounts having a topic rating status and a quality rating status different from the topic rating status and the quality rating status for the messaging session associated with the entering user account at block 406. It is also noted that, where a quality rating has been previously entered by a user of the entering user account in association with another user account, the process 400 may also block distribution of presence information associated with the entering user account from being distributed to the other user account when the quality rating is below a configured quality rating for distribution of presence information associated with the other account. The process 400 may also block distribution of presence information associated with the entering user account from being distributed to other user accounts when a topic rating associated with the entering user access account is different from the topic rating provided upon network entry. Many variations on processing for blocking presence information in association with a purpose for entry into a network for a user account are possible and all are considered within the scope of the present subject matter.

When a determination is made at decision point 404 that a network entry status has not been received at decision point 404 or upon completion of blocking activities for distribution of presence information at block 406, the process 400 retrieves a configured presence filtering profile associated with the entering user account at block 408. The process 400 may retrieve the configured presence filtering profile associated with the entering user account from a memory location, such as the presence configuration information storage area 210 or other area. The process 400 may also determine that a configured presence filtering profile does not exist for the entering user account and may perform additional processing (not shown), such as that described above, to automatically configure and store a presence filtering profile that defines distribution controls for presence information for the entering user account based upon the determined ranking, such as a number of messaging interactions between respective subsets of user accounts, during the present messaging session. In this manner, the process 400 may increase coverage for controls for distribution of presence information for user accounts based upon a configured presence filtering profile.

Upon completion of retrieval of a configured presence filtering profile associated with the entering user account at block 408, the process 400 makes a determination at decision point 410 as to whether an association has been defined for the entering user account. An association may be defined, for example, for collaborative undertakings where multiple users undertake messaging interactions for a purpose and may be stored in association with the retrieved automatically configured presence filtering profile. In such a situation, the process 400 may determine whether such an association has been defined based upon analysis of the retrieved presence filtering profile.

When a determination is made at decision point 410 that the entering user account has a defined association with other user accounts, at block 412 the process 400 blocks presence information distribution associated with a subset of user accounts having the defined association from being distributed to other user accounts that are not associated with the associated subset of user accounts. In this manner, collaborative groups of user accounts may enter a network for messaging interactions without presence information being distributed to user accounts not associated with the group. Further, other user accounts may have presence distribution modified upon entry of a collaborating user account to allow uninterrupted messaging interaction for the intended purpose of the collaboration.

When a determination is made at decision point 410 that the entering user account does not have a defined association with other user accounts or upon completion of presence information blocking at block 412, the process 400 begins message monitoring activities at block 414. At decision point 416, the process 400 makes a determination as to whether a rating for a messaging interaction has been detected and received from a user account associated with the messaging interaction. When a determination is made that a rating for the messaging interaction has been detected and received from a user account associated with the messaging interaction, the process 400 modifies the configured presence filtering profile for the user account based upon the detected rating at block 418. The rating generated by the user account and detected by the process 400 may include a quality rating, a topic rating, or other form of rating associated with the messaging interaction. By modifying the configured presence filtering profile for the user account based upon the detected rating, future presence information filtering may be performed.

When a determination is made at decision point 416 that a rating for a messaging interaction has not been detected and received from a user account associated with the messaging interaction or upon completion of modifications to the configured presence filtering profile for the user account based upon the detected rating at block 418, the process 400 makes a determination at decision point 420 as to whether a request to change the network entry status associated with a user account associated with the monitored messaging interactions has been detected and received. The change to the network entry status may include a change to the topic rating status and/or the quality rating status associated with the messaging session and may be generated by a user of the respective messaging device via a GUI or other input interface on the respective messaging device.

When a determination is made at decision point 420 that a request to change the network entry status associated with a user account associated with the monitored messaging interactions has been detected and received, the process 400 modifies the distribution of presence information based upon the detected change at block 422. As such, a user account may enter a network for one purpose with associated presence information blocking for the messaging session. The user may complete the purpose for the messaging session and may request a change, via the respective messaging device, to the purpose of the messaging session. In response, the process 400 may change the distribution of presence information associated with the user account during runtime to either increase or decrease distribution of presence information based upon the requested and detected change. Accordingly, the process 400 controls distribution of the presence information associated with the user account based upon the changed rating status associated with the user account.

When a determination is made at decision point 420 that a change to the network entry status associated with a user account associated with the monitored messaging interactions has not been detected or upon completion of presence distribution changes at block 422, the process makes a determination at decision point 424 as to whether an exit event has been detected in association with the user account that entered the network. When a determination is made that an exit event has not been detected, the process 400 returns to block 414 to continue monitoring messaging interactions for the messaging session and iterates as described above. When a determination is made that an exit event has been detected, the process 400 returns to decision point 402 to await detection of a network entry event associated with a user account.

As described above in association with FIG. 1 through FIG. 4, the example systems and processes provide automated presence ranking within communication networks. Many other variations and additional activities associated with automated presence ranking within communication networks are possible and all are considered within the scope of the present subject matter.

Those skilled in the art will recognize, upon consideration of the above teachings, that certain of the above examples are based upon use of a programmed processor, such as the CPU 200. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
monitoring, at a presence server, messaging interactions among a plurality of network user access accounts;
ranking the messaging interactions between the plurality of network user access accounts based upon a characteristic of the messaging interactions;
automatically configuring a presence filtering profile that defines distribution controls for presence information for the plurality of network user access accounts based upon the determined ranking; and
controlling distribution of the presence information for the plurality of network user access accounts based upon the configured presence filtering profile.

2. The method of claim 1, wherein:
ranking the messaging interactions between the plurality of network user access accounts based upon the characteristic of the messaging interactions comprises ranking the messaging interactions based upon a number of the messaging interactions between respective subsets of the plurality of network user access accounts; and
controlling the distribution of the presence information for the plurality of network user access accounts based upon the configured presence filtering profile comprises blocking the presence information associated with a subset of the plurality of network user access accounts from being distributed to other of the plurality of network user access accounts without a defined association with the subset of the plurality of network user access accounts.

3. The method of claim 1, further comprising:
detecting, at the presence server, a rating generated by a first of the plurality of network user access accounts associated with a second of the plurality of network user access accounts; and
modifying the configured presence filtering profile for the first of the plurality of network user access accounts based upon the detected rating.

4. The method of claim 3, wherein the rating generated by the first of the plurality of network user access accounts associated with the second of the plurality of network user access accounts comprises one of a quality rating and a topic rating associated with the messaging interactions between the first and second of the plurality of network user access accounts.

5. The method of claim 4, wherein controlling the distribution of the presence information for the plurality of network user access accounts based upon the configured presence filtering profile comprises blocking distribution of the presence information associated with the first of the plurality of network user access accounts from being distributed to the second of the plurality of network user access accounts when the quality rating is below a configured quality rating for distribution of the presence information.

6. The method of claim 1, further comprising:
receiving, in association with a network entry event for the first of the plurality of network user access accounts, a topic rating status and a quality rating status for a messaging session associated with the first of the plurality of network user access accounts; and
wherein controlling the distribution of the presence information for the plurality of network user access accounts based upon the configured presence filtering profile comprises blocking distribution of the presence information associated with the first of the plurality of network user access accounts from being distributed to other of the plurality of network user access accounts having a topic rating status and a quality rating status different from the topic rating status and the quality rating status for the messaging session associated with the first of the plurality of network user access accounts.

7. The method of claim 6, further comprising:
receiving, at the presence server, a request associated with the first of the plurality of network user access accounts to change at least one of the topic rating status and the quality rating status associated with the messaging session associated with the first of the plurality of network user access accounts; and
wherein controlling the distribution of the presence information for the plurality of network user access accounts based upon the configured presence filtering profile comprises controlling distribution of the presence information associated with the first of the plurality of network user access accounts based upon the changed at least one of the topic rating status and the quality rating status associated with the first of the plurality of network user access accounts.

8. A system, comprising:
a memory; and
a processor programmed to:
monitor, at a presence server, messaging interactions among a plurality of network user access accounts;
rank the messaging interactions between the plurality of network user access accounts based upon a characteristic of the messaging interactions;
automatically configure a presence filtering profile that defines distribution controls for presence information for the plurality of network user access accounts based upon the determined ranking;
store the automatically configured presence filtering profile within the memory; and
control distribution of the presence information for the plurality of network user access accounts based upon the configured presence filtering profile.

9. The system of claim 8, wherein:
in being programmed to rank the messaging interactions between the plurality of network user access accounts based upon the characteristic of the messaging interactions, the processor is programmed to rank the messaging interactions based upon a number of the messaging interactions between respective subsets of the plurality of network user access accounts; and
in being programmed to control the distribution of the presence information for the plurality of network user access accounts based upon the configured presence filtering profile, the processor is programmed to block the presence information associated with a subset of the plurality of network user access accounts from being distributed to other of the plurality of network user access accounts without a defined association with the subset of the plurality of network user access accounts.

10. The system of claim 8, wherein the processor is further programmed to:
detect, at the presence server, a rating generated by a first of the plurality of network user access accounts associated with a second of the plurality of network user access accounts; and
modify the configured presence filtering profile for the first of the plurality of network user access accounts based upon the detected rating.

11. The system of claim 10, wherein the rating generated by the first of the plurality of network user access accounts associated with the second of the plurality of network user access accounts comprises one of a quality rating and a topic rating associated with the messaging interactions between the first and second of the plurality of network user access accounts.

12. The system of claim 8, wherein the processor is further programmed to:
receive, in association with a network entry event for the first of the plurality of network user access accounts, a topic rating status and a quality rating status for a messaging session associated with the first of the plurality of network user access accounts; and
wherein, in being programmed to control the distribution of the presence information for the plurality of network user access accounts based upon the configured presence filtering profile, the processor is programmed to block distribution of the presence information associated with the first of the plurality of network user access accounts from being distributed to other of the plurality of network user access accounts having a topic rating status and a quality rating status different from the topic rating status and the quality rating status for the messaging session associated with the first of the plurality of network user access accounts.

13. The system of claim 12, wherein the processor is further programmed to:
receive, at the presence server, a request associated with the first of the plurality of network user access accounts to change at least one of the topic rating status and the quality rating status associated with the messaging session associated with the first of the plurality of network user access accounts; and
wherein, in being programmed to control the distribution of the presence information for the plurality of network user access accounts based upon the configured presence filtering profile, the processor is programmed to control distribution of the presence information associated with the first of the plurality of network user access accounts based upon the changed at least one of the topic rating status and the quality rating status associated with the first of the plurality of network user access accounts.

14. A computer program product, comprising:
a computer readable storage medium having computer readable program code embodied therewith, the computer readable program code comprising:
computer readable program code configured to monitor, at a presence server, messaging interactions among a plurality of network user access accounts;
computer readable program code configured to rank the messaging interactions between the plurality of network user access accounts based upon a characteristic of the messaging interactions;
computer readable program code configured to automatically configure a presence filtering profile that defines distribution controls for presence information for the plurality of network user access accounts based upon the determined ranking; and
computer readable program code configured to control distribution of the presence information for the plurality of network user access accounts based upon the configured presence filtering profile.

15. The computer program product of claim 14, wherein:
the computer readable program code configured to rank the messaging interactions between the plurality of network user access accounts based upon the characteristic of the messaging interactions comprises computer readable program code configured to rank the messaging interactions based upon a number of the messaging interactions between respective subsets of the plurality of network user access accounts; and
the computer readable program code configured to control the distribution of the presence information for the plurality of network user access accounts based upon the configured presence filtering profile comprises computer readable program code configured to block the presence information associated with a subset of the plurality of network user access accounts from being distributed to other of the plurality of network user access accounts without a defined association with the subset of the plurality of network user access accounts.

16. The computer program product of claim 14, further comprising:
computer readable program code configured to detect, at the presence server, a rating generated by a first of the plurality of network user access accounts associated with a second of the plurality of network user access accounts; and
computer readable program code configured to modify the configured presence filtering profile for the first of the plurality of network user access accounts based upon the detected rating.

17. The computer program product of claim 16, wherein the rating generated by the first of the plurality of network user access accounts associated with the second of the plurality of network user access accounts comprises one of a quality rating and a topic rating associated with the messaging interactions between the first and second of the plurality of network user access accounts.

18. The computer program product of claim 17, wherein the computer readable program code configured to control the distribution of the presence information for the plurality of network user access accounts based upon the configured presence filtering profile comprises computer readable program code configured to block distribution of the presence information associated with the first of the plurality of network user access accounts from being distributed to the second of the plurality of network user access accounts when the quality rating is below a configured quality rating for distribution of the presence information.

19. The computer program product of claim 14, further comprising:
computer readable program code configured to receive, in association with a network entry event for the first of the plurality of network user access accounts, a topic rating status and a quality rating status for a messaging session associated with the first of the plurality of network user access accounts; and
wherein the computer readable program code configured to control the distribution of the presence information for the plurality of network user access accounts based upon the configured presence filtering profile comprises computer readable program code configured to block distribution of the presence information associated with the first of the plurality of network user access accounts from being distributed to other of the plurality of network user access accounts having a topic rating status and a quality rating status different from the topic rating status and the quality rating status for the messaging session associated with the first of the plurality of network user access accounts.

20. The computer program product of claim 19, further comprising:
computer readable program code configured to receive, at the presence server, a request associated with the first of the plurality of network user access accounts to change at least one of the topic rating status and the quality rating status associated with the messaging session associated with the first of the plurality of network user access accounts; and
wherein the computer readable program code configured to control the distribution of the presence information for the plurality of network user access accounts based upon the configured presence filtering profile comprises computer readable program code configured to control distribution of the presence information associated with the first of the plurality of network user access accounts based upon the changed at least one of the topic rating status and the quality rating status associated with the first of the plurality of network user access accounts.
